(19) United States
(12) Patent Application Publication
(10) Pub. No.: US 2004/0230394 A1
(43) Pub. Date: Nov. 18, 2004

(54) Vehicle crash simulator with dynamic motion simulation

(76) Inventors: Byron J. Saari, Minneapolis, MN (US); Craig L. Campbell, Maple Grove, MN (US); Myron F. Miller, St. Paul, MN (US); Paul J. Leska, Eden Prairie, MN (US); Richard C. Strand, St. Bonifacius, MN (US); Richard E. Bearden, Arden Hills, MN (US)

Correspondence Address: Deirdre Megley Kvale, WESTMAN, CHAMPLIN & KELLY, P.A., Suite 1600 - International Centre, 900 Second Avenue South, Minneapolis, MN, 55402-3319, US

(21) Appl. No.: 10/810,508

(22) Filed: Mar. 26, 2004

Related U.S. Application Data
(60) Provisional application No. 60/458,275, filed on Mar. 28, 2003.

(51) Int. Cl. G01M 10/00; G01M 15/00; G09B 9/04

(52) U.S. Cl. 702/113; 434/62

(57) ABSTRACT

A vehicle crash simulator employs a plurality of actuators to simulate motions or forces of a crash event. The vehicle crash simulator includes a simulation platform supporting a test specimen or vehicle for analysis. The platform is accelerated along a crash acceleration trajectory and forces are imparted to the platform to simulate a crash pulse or event. Forces are imparted to the simulation platform by a plurality of actuators “on-board” or coupled to the simulation platform for dynamic motion simulation. Multi-axial forces Fₓ, F_{y}, F_{z} are imparted to simulate complex crash motions or forces for realistic crash testing.

The present application is based on and claims the benefit of U.S. provisional patent application Ser. No. 60/458,275, filed Mar. 28, 2003, the content of which is hereby incorporated by reference in its entirety.

### BACKGROUND OF THE INVENTION

A vehicle crash simulator simulates dynamics of a crash to evaluate vehicle occupant safety and conditions during a crash event. A crash simulator uses data from an actual test crash or a computer model to physically simulate movement of a vehicle during a crash for evaluations. During a simulated crash, velocity or acceleration is imparted to a platform carrying a specimen to simulate vehicle accelerations during a crash. Sensors and instruments on stationary mounts or on board the simulation apparatus or specimen collect test data for evaluation.

During a frontal impact crash, a vehicle will experience horizontal acceleration, pitch, heave, bounce and/or other motions. Simulation of pitch, heave, bounce and other motions to a horizontally accelerating specimen enhances test simulation of a crash or frontal impact. The present invention addresses these and other aspects and provides solutions not previously recognized.

### SUMMARY OF THE INVENTION

The present invention relates to a vehicle crash simulator including motion or force simulation. The vehicle crash simulator includes a simulation platform supporting a test specimen or vehicle for analysis. The platform is accelerated and forces are imparted to the platform to simulate a crash pulse or event. Forces are imparted to the simulation platform by a plurality of actuators “on-board” or coupled to the simulation platform to provide dynamic motion simulation. Multi-axial forces are imparted to simulate complex crash motions or forces for more realistic crash testing.

### BRIEF DESCRIPTION OF THE DRAWINGS

FIG. 1 is a schematic illustration of an embodiment of a vehicle crash simulator including dynamic motion simulation.

FIGS. 2-3 are schematic illustrations of embodiments of vehicle crash simulators including a plurality of “on-board” actuators for dynamic motion simulation.

FIGS. 4-9 schematically illustrate embodiments of vehicle crash simulators including a plurality of actuators or system configured to provide multi-axial translation and rotational motion for dynamic motion simulation.

FIGS. 10-11 schematically illustrate an embodiment of a vehicle crash simulator including a plurality of actuators to simulate acceleration and other crash motions.

FIG. 12 is a schematic illustration of a video system feedback for simulation control.

### DETAILED DESCRIPTION OF THE PREFERRED EMBODIMENTS

The present invention relates to a vehicle crash simulator or system 100 including a simulation platform 102. Crash motions or accelerations are imparted to the simulation platform 102 to simulate a crash pulse or event. For test operations, a test specimen 106, such as a vehicle frame, buck, vehicle dash, seat, is supported on the simulation platform 102. Transducers, instruments or sensors can be mounted on the simulation platform 102, or the specimen 106 or alternately “off board” separate from the simulation platform 102, to collect crash data during the simulated crash event. The crash data is used to analyze vehicle (for example frame, buck, dash or seat) or occupant reaction and interaction to the simulated crash event.

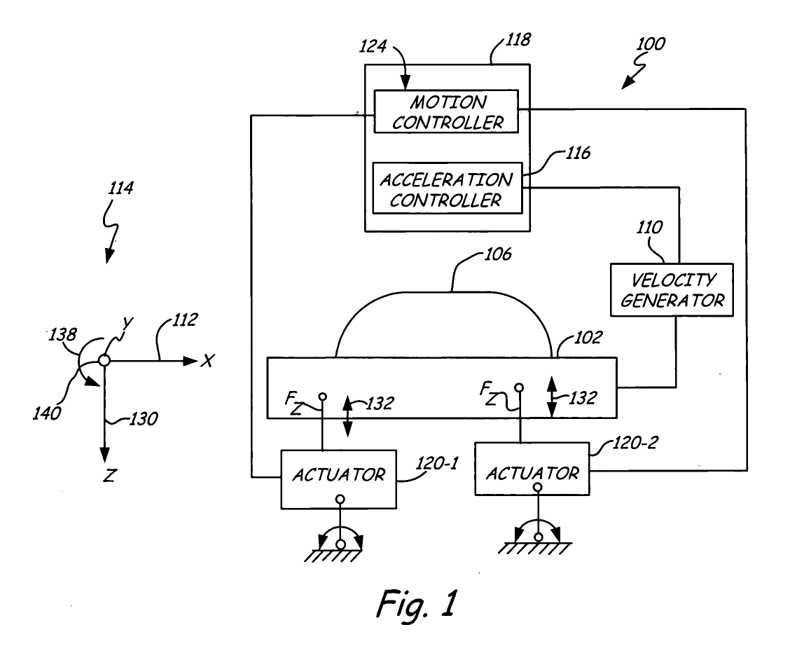

As schematically shown in FIG. 1, the system 100 includes velocity generator 110 to supply a crash acceleration or pulse to the simulation platform 102 along a horizontal acceleration trajectory (i.e., along x-axis 112-relative to the illustrated x, y, z coordinate system 114). The velocity generator 110 is operated by a acceleration controller 116 of a system controller 118. The acceleration controller 116 is configured to provide a control signal or input to the velocity generator 110 to operate or control the velocity generator 110 to simulate crash accelerations based upon actual crash acceleration data or a model acceleration profile.

Crash simulation system 100 also includes a motion generation system coupled to the simulation platform 102 to simulate crash motions or forces in addition to motion along the x-axis trajectory. In the illustrated embodiment of FIG. 1, the motion generation system includes a plurality of actuators 120-1, 120-2 translationally fixed to the simulation platform 102 and movable with the platform 102 to impart additional crash motions or forces. The plurality of actuators 120-1, 120-2 are operated by a motion controller 124 of the system controller 118 to simulate motions or forces of a crash event.

In the illustrated embodiment of FIG. 1, actuators 120-1, 120-2 are energizable to impart force F_{z} or motion relative to a z-axis 130 as illustrated by arrow 132. Application of force F_{z} is used to simulate bounce or heave for crash simulation. Actuators 120-1, 120-2 are spaced relative to a longitudinal length (along x-axis 112) of the platform 102 to impart a pitch or pitching motion to the simulation platform 102. In particular, actuators 120-1, 120-2 are operated to provide a different force F_{z} amplitude between the longitudinally spaced actuators 120-1, 120-2 to provide a pitching motion as illustrated by arrow 138 relative to y-axis 140. The pitching angle or amplitude is a function of the amplitude differential between the actuators 120-1 and 120-2.

As described, the actuators 120-1, 120-2 are translationally fixed relative to the platform 102 and movable with the platform 102 to impart crash motions and forces to the platform 102 at fixed positions irrespective of acceleration of the platform 102. In the illustrated embodiment, the actuators 120-1, 120-2 are “off-board” and are pivotally connected to a base or fixture as schematically shown, although application is not limited to the particular embodiment shown in FIG. 1. Although two actuators 120-1, 120-2 are illustrated, simulation is not limited to the two actuators 120-1, 120-2 shown.

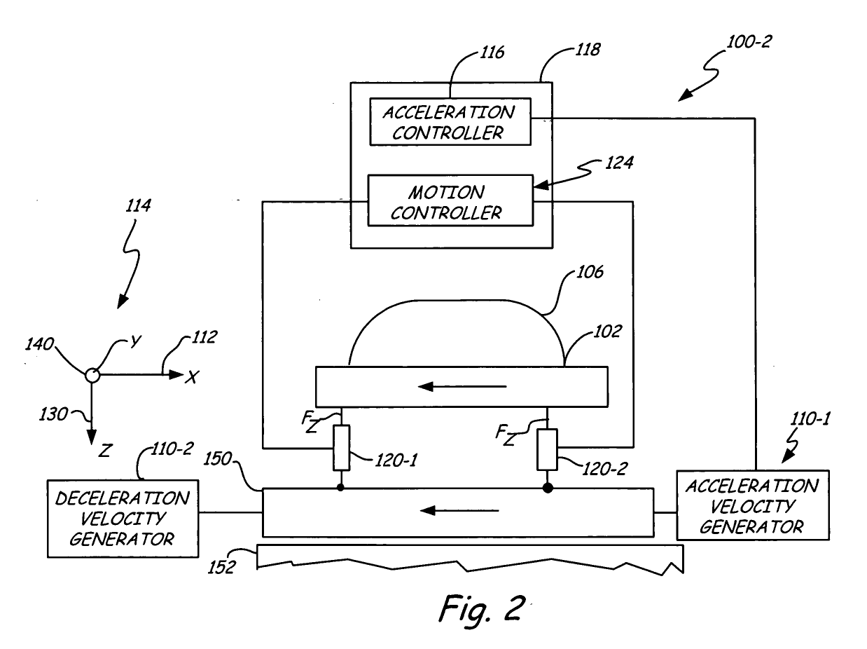

FIG. 2 illustrates an embodiment of a simulation platform 102 “on board” a base sled 150 and movable with the base sled 150 to simulate motion of the platform 102 along track 152. The base sled 150 is accelerated along track 152 by a velocity generator 110-1 which is controlled or operated by the acceleration controller 116 of the system controller 118. The “on-board” platform 102 is accelerated by the base sled 150 to simulate motion and acceleration of the platform 102 (and specimen 106).

In the illustrated embodiment, the simulator includes a deceleration velocity generator 110-2 to slow or deceleration the simulation platform 102 following the crash pulse or simulation. Inclusion of a deceleration velocity generator 110-2 reduces system dimensions or length (e.g. track length 152) required for test simulations. Although, the illustrated embodiment of FIG. 2 includes a deceleration velocity generator 110-2, application is not limited to the particular embodiment of FIG. 2 including an acceleration velocity generator 110-1 and deceleration velocity generator 110-2 as shown.

In the illustrated embodiment, the platform 102 is coupled to the base sled 150 through actuators 120-1, 120-2 to impart crash motions or forces to the accelerating platform 102. As shown actuators 120-1, 120-2 are “on board” the base sled 150 and movable therewith to impart crash motions or forces (Force F_{z}) to the accelerating platform 102 as the platform 102 moves or accelerates along and after an acceleration stroke. Actuators 120-1, 120-2 are independently actuated through motion controller 124 to impart desired crash motions or forces.

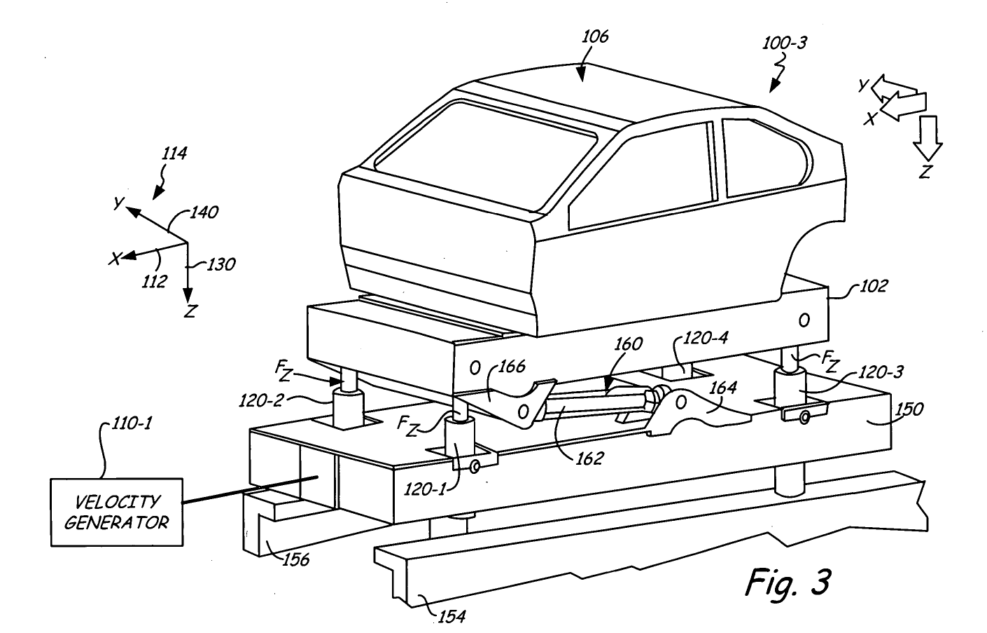

FIG. 3 illustrates an embodiment of a crash simulator or system 100-3 including a plurality of “on-board” actuators 120-1, 120-2, 120-3, 120-4 movable along track or rails 154, 156 where like numbers are used to refer to like parts in the previous FIGS. Actuators 120-1, 120-2, 120-3, 120-4 are energized to impart force F_{z} to simulate translational motion along the z-axis 130 such as heave and bounce and to impart rotational or pitching motions relative to the y-axis 140 via the longitudinally spaced (i.e., longitudinally spaced relative to the x-axis) actuators 120-1, 120-2, 120-3, 120-4 as shown.

In the illustrated embodiment, the simulation platform 102 is movably coupled to the base sled 150 via the actuators 120-1, 120-2, 120-3, 120-4 and a linkage assembly 160. As shown, the linkage assembly 160 includes a link arm 162 rotationally coupled to the base sled 150 through bracket 164 and rotationally coupled to the simulation platform 102 through bracket 166 to allow rotational movement (relative to the y-axis 140) and translational movement (along z-axis 130) of the simulation platform 102.

In an illustrated embodiment, actuators comprise a piston movable relative to an actuator cylinder to impart force or motion to the platform 102. Actuators can supply force and velocity pneumatically, hydraulically or using alternate methods, such as electric actuators to actuate the platform 102 to simulate crash motions. Electric energy storage or high-pressure accumulator tanks, pressure lines and pumps of actuator components can be carried “on board” the base sled 150 in illustrated embodiments although application is not so limited.

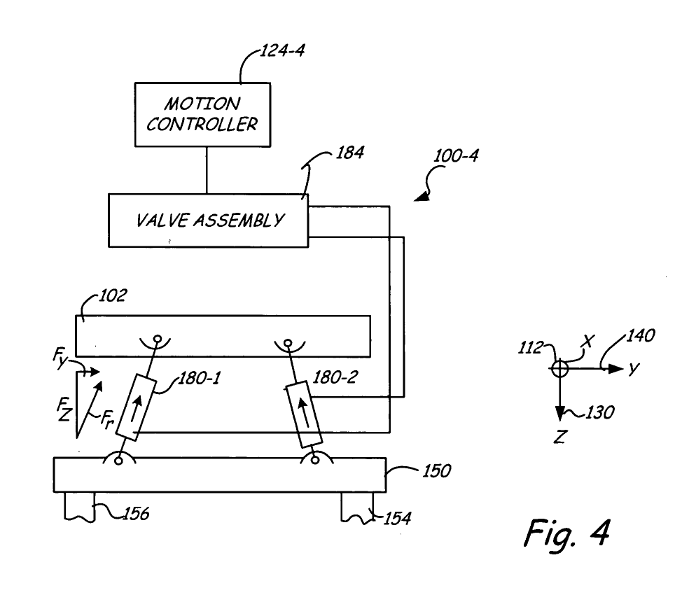

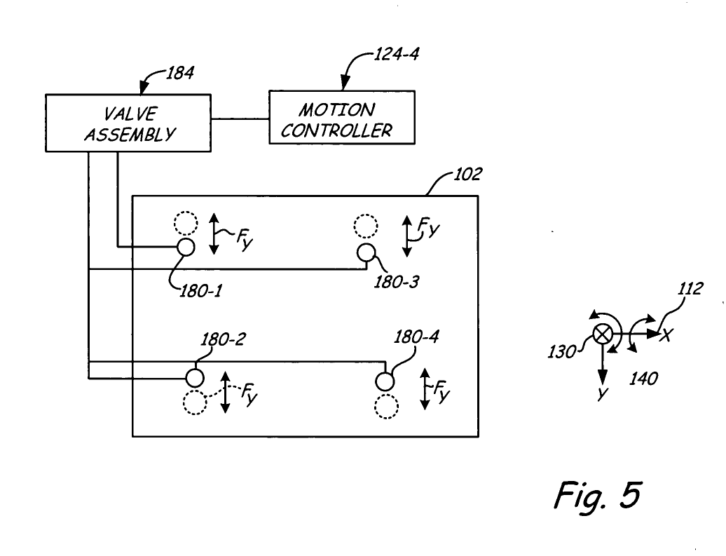

FIGS. 4-5 illustrate an embodiment of a crash simulator system 100-4 including simulation platform 102 movable relative to multiple degrees of freedom to simulate complex crash motions. The simulation platform 102 is coupled to base sled 150 movable along track or rails 154, 156 to impart an acceleration pulse to the platform 102 as described in previous embodiments. The motion generator includes a plurality of “on-board” actuators 180-1, 180-2, 180-3, 180-4. A motion controller 124-4 is coupled to the actuators 180-1, 180-2, 180-3, 180-4 to independently actuate the plurality of actuators 180-1, 180-2, 180-3, 180-4 to simulate particular crash motions or forces.

In an illustrated embodiment, the motion controller 124-4 independently actuates the plurality of actuators 180-1, 180-2, 180-3, 180-4 through operation of a valve assembly 184 for example for a hydraulic system or alternatively other system can be used to independently actuate the plurality of actuators 180-1, 180-2, 180-3, 180-4 and application is not limited to a particular embodiment.

As illustrated in FIGS. 4-5, actuators 180-1 and 180-2, as well as actuators 180-3 and 180-4 are spaced relative to a transverse width (y-axis 140) of the simulation platform 102. Actuators 180-1, 180-2, 180-3 and 180-4 are inclined between the base sled 150 and platform 102 so that actuators 180-1, 180-2, 180-3, 180-4 impart a resultant force Fᵣ including a F_{z} force component along the z-axis 130 and an F_{y} force component along the y-axis 140.

Platform 102 is coupled to the base sled 150 via actuators 180-1, 180-2, 180-3, 180-4. Actuators 180-1, 180-2, 180-3, 180-4 are movably coupled to the platform 102 and base sled 150 to support the platform 102 relative to multiple degrees of freedom to provide multi-axis translational and rotational motion. Actuators 180-1, 180-2, 180-3, 180-4 are energized via motion controller 124-4 to impart multi-axis translation motions or forces, F_{z} and F_{y} and multi-axis rotational motion via force components F_{y} and F_{z}.

Although FIGS. 4-5 illustrate a particular “on-board” embodiment, application is not so limited and actuators 180-1, 180-2, 180-3, 180-4 can be translationally fixed to the simulation platform and pivotally connected to a base or fixture to provide multi-axial forces Fₓ and F_{z} to the simulation platform 102 for a “sled-less” system.

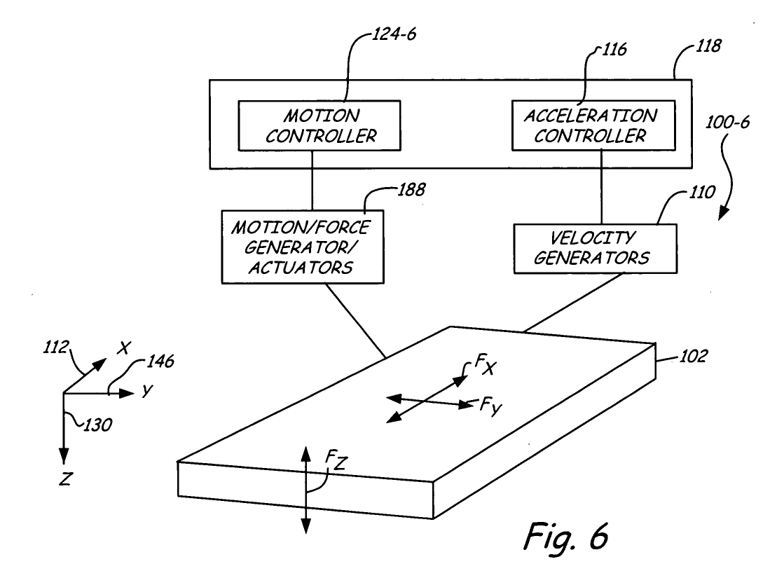

FIG. 6 illustrates an embodiment of a crash simulation system 100-6 including a simulation platform 102 which is floatably supported relative to six degrees of freedom, including multi-axis translational motion or force Fₓ, F_{y}, F_{z} along the x, y, z axes 112, 140, 130 and rotational motion about the x, y, z, axes (e.g. roll(x), pitch(y) and yaw(z)). As schematically shown, motion controller 124-6 is coupled to the simulation platform 102 to simulate motions or force relative to the six degrees of freedom including for example, pitch about the y-axis, heave and bounce along the z-axis, transverse motion along the y-axis, yaw about the z-axis and roll about the x-axis, and longitudinal along the x-axis or other motions for crash simulation. The motion controller 124-6 controls a motion generator or actuators as illustrated by block 188 as platform 102 is accelerated to simulate a crash event.

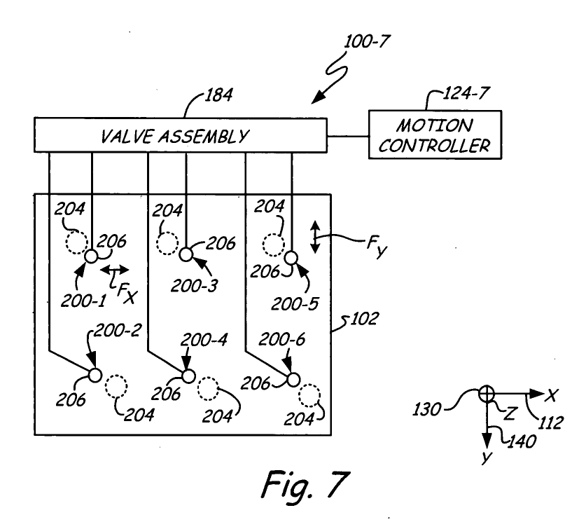

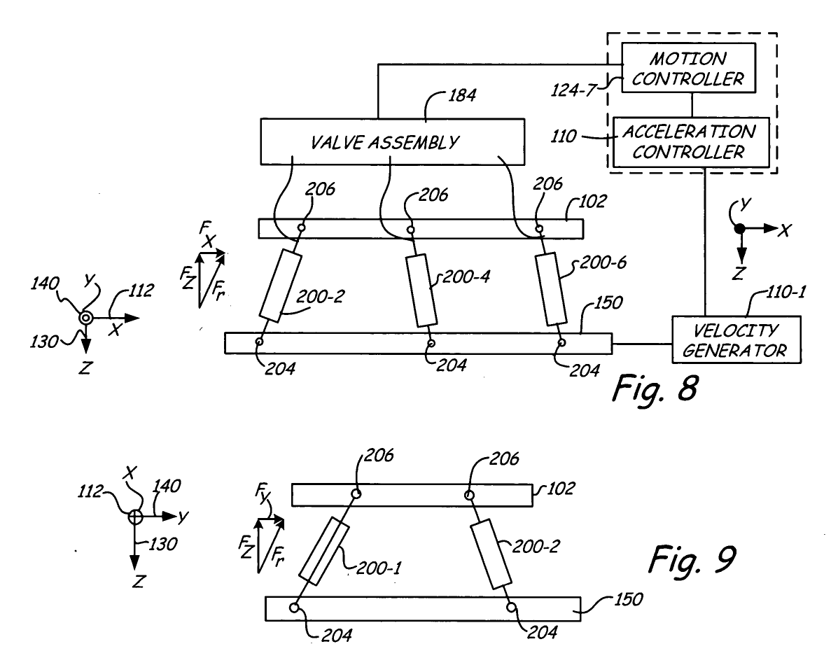

FIGS. 7-9 illustrate an embodiment of a simulation system 100-7 including multi-axial motion simulation relative to six degrees of freedom where like numbers are used to like parts in the previous FIGS. As shown, the system includes a plurality of actuators 200-1, 200-2, 200-3, 200-4, 200-5, 200-6 which as shown in FIGS. 8-9 are “on board” base sled 150, and connect or support the platform 102 relative to the base sled 150.

As shown in FIGS. 7-8, the actuators 200-1, 200-2, 200-3, 200-4, 200-5, 200-6 are inclined relative to the x-axis between the platform 102 and base sled 150 to provide a resultant force Fᵣ including a F_{z} component and a Fₓ component to provide translational motion relative to the x and z axes 112, 130. As shown, base ends 204 of the actuators 200-1, 200-2, 200-3, 200-4, 200-5, 200-6 are longitudinally (relative to the x-axis) offset from the platform ends 206 of the actuators 200-1, 200-2, 200-3, 200-4, 200-5, 200-6 to impart the Fₓ force component.

As shown relative to FIGS. 7 and 9, base end 204 of actuators 200-1, 200-2, 200-3, 200-4, 200-5, 200-6 are also transversely offset from the platform ends 206 relative to the y-axis 134 to provide a F_{y} force component. The F_{y}, Fₓ, F_{z} force components provide multi-axial translation motion or force (for example relative to x, y, z axes) and rotational motions (roll, pitch and yaw ) relative six degrees of freedom. Ends 204 and 206 of actuators 200-1, 200-2, 200-3, 200-4, 200-5, 200-6 are coupled to the base sled 150 and platform 102 via spherical connections to allow multi-axial movement of the platform 102 relative to six degrees of freedom.

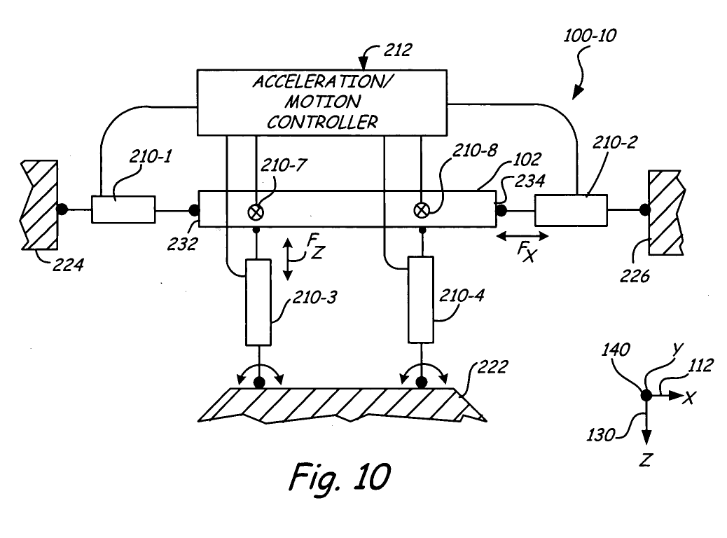

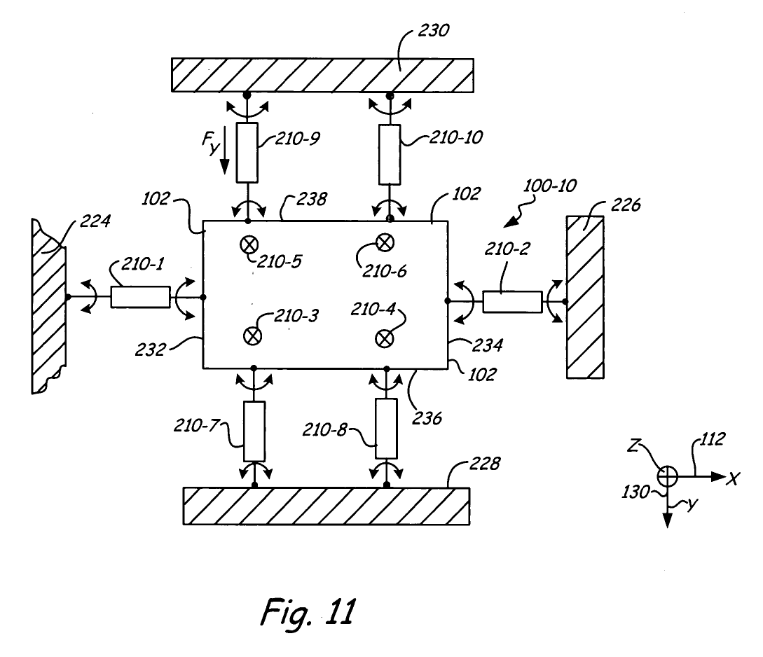

FIGS. 10-11 illustrate an alternate “off-board or sled-less” embodiment of a simulator system 100-10 where like numbers are used to refer to like numbers in the previous FIGS. As shown, the simulator system 100-10 includes a floating simulation platform 102 which carries a specimen or test vehicle (not shown). A plurality of piston/cylinder actuators 210 are coupled to the platform 102 and are operated to simulate acceleration and other crash motions.

As shown, the system includes a plurality of horizontally orientated (i.e. x-axis) actuators 210-1, 210-2 which are orientated to provide motion/acceleration or force Fₓ along the x-axis under the control of motion controller 212 to simulate crash accelerations. As shown, motion or force F_{z} along the z-axis is imparted to the platform 102 via a plurality of vertically orientated actuators 210-3, 210-4, 210-5, 210-6 and motion or force F_{y} is imparted to the platform via a plurality of transversely supported actuators 210-7, 210-8, 210-9, 210-10 under the control of motion controller 212.

As shown, the platform 102 is floatably supported relative to base or fixed support 222 and fixed supports or walls 224, 226, 228, 230 via the plurality of actuators 210-1 through 210-10. Actuators 210-1 and 210-2 are coupled between opposed ends 232, 234 of the platform and fixed supports 224, 226 via spherical connections to impart force Fₓ to simulate motion. Actuators 210-3, 210-4, 210-5, 210-6 are coupled to base or support 222 to impart a force F_{z} relative to a surface of the platform 102. Actuators 210-7, 210-8, 210-9, 210-10 extend between opposed sides 236, 238 of the platform 102 and fixed supports 228, 230 to impart motion and/or force F_{y} in response to input of the motion controller 212 to simulate crash acceleration and forces.

Actuators 210-1 through 210-10 are coupled to the platform 102 and supports 224, 226, 228, 230 through a spherical connection to impart complex motions and forces by extending or retracting selected pistons based upon a desired crash profile. Although a particular actuator type and number or orientation of actuators is shown, application of the “sled-less” system is not limited to a particular type of, number of, or orientations for the actuators 210-1 through 210-10.

Thus, as described application of the present invention includes sled-type systems as illustrated in FIGS. 4-5 or FIGS. 7-9 to provide forces Fₓ, F_{y} or F_{z} via a plurality of “on-board” actuators or alternatively a “sled-less” system which is accelerated and decelerated via actuators 210-1 and 210-2. Alternatively, multiple axial forces can be supplied to a simulation platform 102 through a combination of actuators “on-board” a base sled and actuators adapted to supply force to the simulation platform through a base sled 150. For example, multiple axis forces Fₓ, F_{y}, or F_{z} can be supplied through actuators “on-board” the base sled 150 and forces Fₓ, F_{y} or F_{z} and acceleration can be supplied to the platform 102 via “off-board” actuators through the base sled 150.

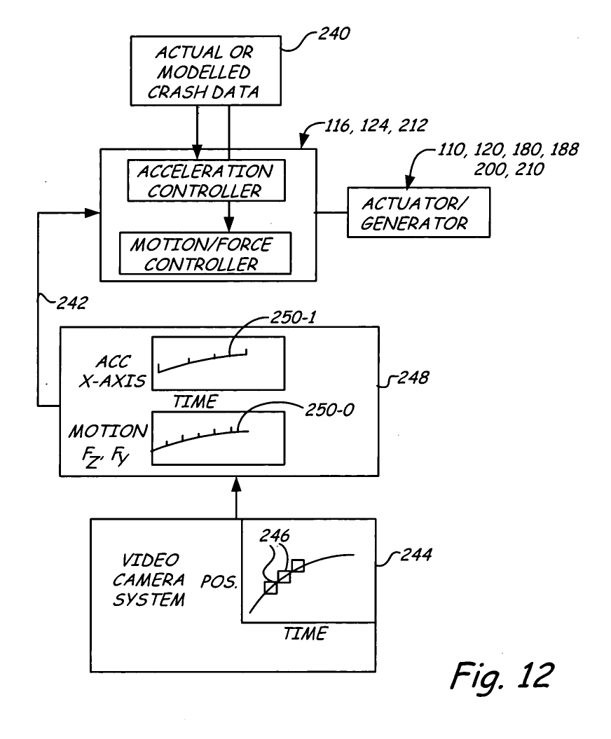

As described, crash simulation systems simulate crash acceleration and motions to analyze vehicle reaction and occupant safety. As illustrated in FIG. 12, systems use an acceleration/motion controller 124, 212 to impart motion and acceleration to a specimen based upon actual crash data or modeled simulation as illustrated by block 240. The present invention provides feedback from test simulations to calibrate or adjust control parameters so that the simulator accurately simulates actual or modeled crash motions or acceleration. As shown in FIG. 12, motion and acceleration feedback 242 is provided by a video imaging system 244.

The video imaging system 244 uses a digital imager or CCD (Charge Coupled Device) to capture time elapsed images 246 of the platform 102, occupant(s) or crash simulation. The images 246 are processed by image processor 248 to extract acceleration and/or motion profiles 250-1, 250-2 of the platform 102 or specimen 106 or occupant(s) relative to time to provide motion feedback 242 to the motion controllers 116, 124, 212 to adjust operating parameters of the simulators based upon the feedback 242.

The video imaging system 242 can be positioned “on board” the system or platform 102, and/or off-board the system or platform 102. Feedback or image data to the image processor 248 or simulators 116, 124, 212 can be on-line to provide dynamic simulation control or off-line to model multiple simulations or tests to adjust test parameters relative to actual or modeled crash data 240. In one illustrative embodiment, the video imaging system 242 is coupled to a dummy or occupant to collect injury data and test parameters or forces of the simulators are adjusted based upon the processed injury data relative to a desired injury criteria or profile for the test simulation.

Although the present invention has been described with reference to preferred embodiments, workers skilled in the art will recognize that changes may be made in form and detail without departing from the spirit and scope of the invention.

What is claimed is:

1. A vehicle crash simulator comprising:
a simulation platform;
a motion generator including a plurality of actuators translationally fixed to the simulation platform; and
a motion controller configured to operate the plurality of actuators to impart a simulated crash motion or force to the simulation platform.

2. The vehicle crash simulator of claim 1 and further comprising the velocity generator coupled to the motion controller and configured to operate the velocity generator to impart a crash acceleration to the simulation platform.

3. The vehicle crash simulator of claim 2 wherein the simulation platform is on-board a base sled and the velocity generator is coupled to the base sled to accelerate or move the base sled to impart the crash acceleration to the simulation platform.

4. The vehicle crash simulator of claim 3 wherein the plurality of actuators are on-board the base sled and movable therewith along an acceleration stroke.

5. The vehicle crash simulator of claim 3 wherein the base sled is movable along a track formed of opposed spaced rails.

6. The vehicle crash simulator of claim 1 wherein the plurality of actuators are coupled to the simulation platform and configured to impart force and motion F_{z} along a z-axis of the simulation platform and one of force and motion F_{y} or force and motion Fₓ along x or y axes of the platform.

7. The vehicle crash simulator of claim 1 wherein the plurality of actuators are coupled to the simulation platform to impart a resultant force Fᵣ or motion having multi-axis force components.

8. The vehicle crash simulator of claim 1 the plurality of actuators are coupled to opposed ends of the simulation platform and operable by the motion controller to impart a simulated crash acceleration.

9. The vehicle crash simulator of claim 1 including a plurality of actuators coupled to opposed sides of the simulation platform to simulate a force F_{y} along the y-axis and a plurality of actuators coupled to the simulation platform to simulate force F_{z} along the z-axis.

10. A vehicle crash simulator comprising:
a simulation platform;
a motion generator including a plurality of actuators operably coupled to the simulation platform to impart a plurality of multi-axial forces F_{z} along a z-axis, Fₓ along an x-axis or F_{y} along a y-axis to the simulation platform; and
a motion controller configured to operate the plurality of actuators to impart the plurality of multi-axial forces.

11. The vehicle crash simulator of claim 10 wherein the plurality of actuators are on-board a base sled and movable therewith along a track to simulate crash accelerations.

12. The vehicle crash simulator of claim 11 wherein the plurality of actuators are inclined between the base sled and the platform to impart a resultant Force Fᵣ including a F_{z} force component and a force Fₓ or force F_{y} component.

13. The vehicle crash simulator of claim 10 wherein the plurality of actuators are operable to impart force F_{z}, force F_{y} and force Fₓ relative to x, y and z axes.

14. The vehicle crash simulator of claim 11 wherein the simulator includes a velocity generator to impart a crash acceleration pulse to the base sled.

15. The vehicle crash simulator of claim 11 wherein the simulation platform is coupled to the base sled via the plurality of actuators.

16. The vehicle crash simulator of claim 10 wherein the plurality of actuators impart force Fₓ along the x-axis to simulate crash accelerations and force F_{z} and force F_{y} to simulate crash motions.

17. A vehicle crash simulator comprising:
a simulation platform;
a simulator configured to impart acceleration or force to the simulation platform to simulate crash accelerations or motions; and
a video imaging system including a video camera to capture an image of a simulated crash event to control operation of the simulator.

18. The crash simulator of claim 17 wherein the video imaging system includes an image processor to provide acceleration or motion feedback to the simulator.

19. A method for simulating a vehicle crash comprising the steps of:
simulating a crash acceleration pulse by accelerating a base sled having a platform carried on board the base sled; and
simulating crash forces or motions through a plurality of actuators on board the base sled.

20. The method of claim 19 wherein the crash acceleration and the crash forces or motions are simulated based upon feedback from a video imaging system to control the plurality of actuators.

21. The method of claim 19 wherein the step of simulating the crash forces or motions simulates motion relative to six degrees of freedom.

22. A method for simulating a vehicle crash comprising the steps of:
controlling a plurality of actuators connected to a simulation platform to impart force to the simulation platform along multiple x, y or z axes to simulate crash acceleration or motions.

23. The method of claim 22 wherein the step of simulating crash acceleration or motions comprises:
actuating the plurality of actuators to impart multiple forces, force F_{z}, force Fₓ or force F_{y} to the simulation platform.

24. The method of claim 22 wherein the step of simulating crash forces or motions simulates pitch, yaw and roll motion of a vehicle crash.

25. The method of claim 22 and further comprising the step of:
accelerating a base sled carrying the simulation platform to simulate crash acceleration.

26. The method of claim 22 wherein the step of controlling the plurality of actuators provides a force Fₓ to simulate a crash acceleration.
